(19) United States
(12) Patent Application Publication
(10) Pub. No.: US 2016/0335265 A1
(43) Pub. Date: Nov. 17, 2016

(54) USER TERMINAL APPARATUS AND CONTROLLING METHOD THEREOF

(71) Applicant: SAMSUNG ELECTRONICS CO., LTD., Suwon-si (KR)

(72) Inventors: Sun-eung PARK, Suwon-si (KR); Hyun-cheol PARK, Suwon-si (KR); Young-hyun KIM, Gunpo-si (KR); Dong-ju LEE, Suwon-si (KR)

(73) Assignee: SAMSUNG ELECTRONICS CO., LTD., Suwon-si (KR)

(21) Appl. No.: 15/099,824

(22) Filed: Apr. 15, 2016

Related U.S. Application Data
(60) Provisional application No. 62/159,511, filed on May 11, 2015.

(30) Foreign Application Priority Data
Jul. 15, 2015 (KR) 10-2015-0100583

(51) Int. Cl. G06F 17/30

(52) U.S. Cl. CPC G06F 17/3053; G06F 17/30554

(57) ABSTRACT

A user terminal apparatus is provided. The user terminal apparatus includes a storage configured to store usage history data of an application which is installed in the user terminal apparatus and a processor configured to extract usage history data related to a user interaction from the stored usage history data, and determine whether to inactivate the application based on the extracted usage history data. Accordingly, the efficiency of resources and battery of the user terminal apparatus is improved and thus, user convenience is also enhanced.

### CROSS-REFERENCE TO RELATED APPLICATIONS

This application claims priority from Korean Patent Application No. 10-2015-0100583, filed in the Korean Intellectual Property Office on Jul. 15, 2015, and U.S. Provisional Patent Application No. 62/159,511, filed in the United States Patent and Trademark Office on May 11, 2015, the disclosures of which are incorporated by reference herein.

### BACKGROUND

1. Field

Aspects of the exemplary embodiments relate to a user terminal apparatus and a controlling method thereof, and more particularly, to a user terminal apparatus to manage an application which is installed in the user terminal apparatus and a controlling method thereof.

2. Description of the Related Art

With the development of electronic technologies, various types of electronic products have been developed and distributed, and electronic apparatuses with various functions which improve user convenience have been used. Further, various applications to improve user convenience have been developed and installed in electronic apparatuses.

The execution of applications can be divided into foreground execution where applications are executed while being displayed on a display and background execution where applications are not displayed on a display but occupy resources, and when a predetermined event occurs, notification is provided to a user.

In the related art, due to hardware limitations (such as, shortage of memory, etc.), those applications which are not essential cannot be executed in background, or even if executed in background, non-essential applications are terminated after a certain time elapses. However, recently, as a mass memory is provided, most applications can be executed in background.

As it is possible to convert background execution to foreground execution swiftly, a user may feel that applications are performed quickly. However, as applications occupy resources continuously when they are executed in background, battery efficiency is inevitably compromised.

Accordingly, a function to terminate the background execution of applications is provided. However, the related art function of terminating background execution has disadvantages as all applications which are currently executed are terminated or applications are terminated contrary to a user's intention. In addition, in some Operating Systems (OSs), terminated applications are executed automatically, which causes disadvantages.

### SUMMARY

It is an aspect to provide a user terminal apparatus which determines whether to inactivate an application by extracting usage history data related to a user interaction from usage history data of the application installed in the user terminal apparatus and a controlling method thereof.

According to an aspect of an exemplary embodiment, there is provided a user terminal apparatus comprising a storage configured to store usage history data of an application which is installed in the user terminal apparatus; and a processor configured to extract usage history data related to a user interaction from the stored usage history data, and determine whether to inactivate the application based on the extracted usage history data.

The usage history data may include information regarding execution start times of the application during a period, wherein the processor determines whether to inactivate the application based on differences between each of the execution start times and a present time.

The processor may calculate individual weighted values regarding each of the execution start times based on the differences between each of the execution start times and a present time, and determine whether to inactivate the application using a sum of the calculated individual weighted values.

The processor may calculate an individual weighted value corresponding to differences between each of the execution start times and a present time using a weight function.

The period may be divided into a plurality of sub periods, wherein the processor, in response to a plurality of execution start times being included in a same sub period from among the plurality of sub periods, calculates the individual weighted value by changing differences between each of the plurality of execution start times and a present time to be identical.

The processor may calculate an individual weighted value of usage history where a user interaction is input to be higher than an individual weighted value of usage history where a user interaction is not input after a notification is generated by the application.

The processor may calculate an individual weighted value of usage history where a user interaction is input without a notification by the application to be higher than an individual weighted value of usage history where a user interaction is input after a notification is generated by the application.

The apparatus may further comprise a display configured to display an application list, wherein the processor controls the display to display applications which are determined to be inactivated differently from other applications in the application list.

The processor may determine whether to inactivate the application based on the extracted usage history data either when the user terminal apparatus is recharged or when a time arrives.

The usage history data related to a user interaction may include a title, an execution start time and an execution end time of the application, wherein the processor, in response to a difference between the execution start time and the execution end time being greater than a threshold value, stores the usage history data in the storage.

According to another aspect of an exemplary embodiment, there is provided a controlling method of a user terminal apparatus, the method comprising storing usage history data of an application which is installed in the user terminal apparatus; extracting usage history data related to a user interaction from the stored usage history data; and determining whether to inactivate the application based on the extracted usage history data.

The usage history data may include information regarding execution start times of the application during a period, wherein the determining comprises determining whether to inactivate the application based on differences between each of the execution start times and a present time.

The determining may comprise calculating individual weighted values regarding each of the execution start times based on the differences between each of the execution start times and a present time; and determining whether to inactivate the application using a sum of the calculated individual weighted values.

The calculating may comprise calculating an individual weighted value corresponding to differences between each of the execution start times and a present time using a weight function.

The period may be divided into a plurality of sub periods, wherein the calculating comprises, in response to a plurality of execution start times being included in a same sub period from among the plurality of sub periods, calculating the individual weighted value by changing differences between each of the plurality of execution start times and a present time to be identical.

The calculating may comprise calculating an individual weighted value of usage history where a user interaction is input to be higher than an individual weighted value of usage history where a user interaction is not input after a notification is generated by the application.

The calculating may comprise calculating an individual weighted value of usage history where a user interaction is input without a notification by the application to be higher than an individual weighted value of usage history where a user interaction is input after a notification is generated by the application.

The determining may further comprise displaying applications which are determined to be inactivated differently from other applications in an application list.

The determining may comprise determining whether to inactivate the application based on the extracted usage history data either when the user terminal apparatus is recharged or when a time arrives.

The usage history data related to a user interaction may include a title, an execution start time and an execution end time of the application, wherein the storing comprises, in response to a difference between the execution start time and the execution end time being greater than a threshold value, storing the usage history data.

The processor may inactivate the application based on the determination.

According to another aspect of an exemplary embodiment, there is provided a user terminal apparatus comprising a storage configured to store usage history data of an application; and a processor configured to monitor the stored usage history data for an inactivation condition, and automatically inactivate the application when the inactivation condition occurs.

The inactivation condition may comprise a case in which the application has not been used over a period of time.

The usage history data may include execution start times of the application over a period of time.

The usage history data may comprise usage history data as a result of a user interaction and usage history data which encourages a user interaction even though there is no user interaction.

### BRIEF DESCRIPTION OF THE DRAWINGS

The above and/or other aspects will be more apparent by describing certain exemplary embodiments with reference to the accompanying drawings, in which:

FIGS. 1A and 1B are block diagrams illustrating configurations of a user terminal apparatus according to exemplary embodiments;

FIGS. 2A-2E are views provided to explain a method of determining whether to inactivate an application according to exemplary embodiments;

FIGS. 3A-3C are views provided to explain storage of usage history data of an application according to exemplary embodiments;

FIGS. 4A-4E are views provided to explain various analysis screens which are provided according to exemplary embodiments;

FIGS. 5A-5B are views provided to explain an operation of inactivating an application according to exemplary embodiments;

FIGS. 6A-6B are views provided to explain an example of providing a related application according to exemplary embodiments;

FIG. 7 is a view provided to explain an example of determining whether to inactivate an application using a server according to another exemplary embodiment; and

FIG. 8 is a flowchart provided to explain a controlling method of a user terminal apparatus according to an exemplary embodiment.

### DETAILED DESCRIPTION

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

Hereinafter, various exemplary embodiments will be described in detail with reference to the accompanying drawings.

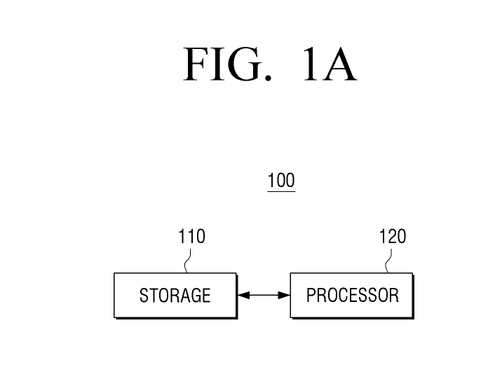

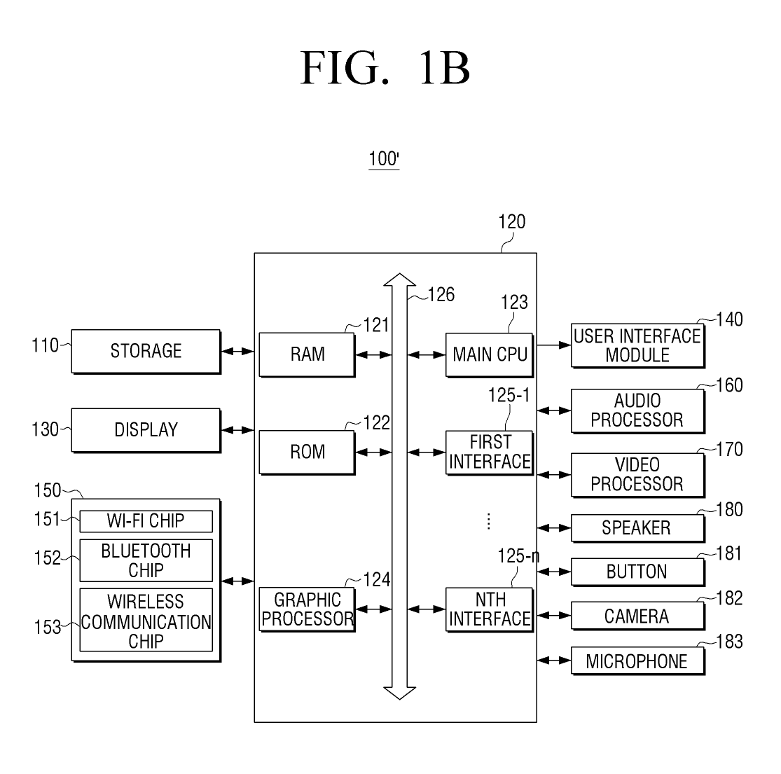

FIG. 1 is a block diagram illustrating configuration of a user terminal apparatus 100 according to an exemplary embodiment.

Referring to FIG. 1A, the user terminal apparatus 100 includes a storage 110 and a processor 120.

FIG. 1A illustrates various elements in a comprehensive manner, assuming that the user terminal apparatus 100 provides various functions such as a storage function and a control function, etc. Accordingly, depending on exemplary embodiments, some of the elements illustrated in FIG. 1A may be omitted or changed, and other elements may be added.

The storage 110 may store usage history data of an application installed in the user terminal apparatus 100. For example, usage history data of an application includes usage history data of execution both in foreground and background. In addition, usage history data of an application may include the title, the execution start time and the execution end time of an application. However, this is only an example, and usage history data of an application may further include the resources occupation rate, the battery level, etc. of an application.

The storage may store usage history data according to the type of application. However, this is only an example, and the storage 110 may store usage history data by grouping applications. Applications may be grouped according to the type, the capacity, the usage time, etc. of the applications.

The processor 120 may control the overall operations of the user terminal apparatus 100.

The processor 120 may extract usage history data related to a user interaction from stored usage history data. As described above, the usage history data may include the title, the execution start time, the execution end time, the resources occupation rate, the battery level, etc. of an application.

The processor 120 may extract usage history data by a user interaction from the usage history data. For example, if an application is executed by a user interaction of touching a widget, the processor 120 may extract the execution start time and the execution end time regarding the application corresponding to the widget.

In addition, the processor 120 may extract usage history data related to a user interaction without a user interaction. For example, when receiving a message, a message application may provide a notification to notify a user that the message has been received. If there is no user interaction regarding the notification, the processor 120 may not perform any further operation. However, the processor 120 may determine that even if there is no user interaction regarding the notification, the notification is usage history data related to a user interaction considering that the notification encourages a user interaction. Hereinafter, usage history data related to a user interaction includes not only usage history data by a user interaction but also usage history data which encourages a user interaction even though there is no user interaction.

If a notification for receiving a message is provided to a user and there is a user interaction regarding the notification, the processor 120 may display the specific contents of the message. The usage history as described above corresponds to usage data involving a user interaction.

There may be some applications which are executed without a user's execution command. Such operations of the applications may also be stored as usage history data. The processor 120 may determine that such operations are usage history data which is not related to a user interaction.

The processor 120 may determine whether to inactivate an application based on extracted usage history data.

The usage history data includes information regarding execution start times of an application during a period, and the processor 120 may determine whether to inactivate an application based on differences between each of the execution start times and a present time. The period may be predetermined.

The processor may calculate individual weighted values regarding each of the execution start times based on differences between each of the execution start times and a present time, and determine whether to inactivate an application using a sum of the calculated individual weighted values.

In particular, the processor 120 may calculate individual weighted values corresponding to differences between each of the execution start times and a present time using a weight function.

In the case that the period may be divided into a plurality of sub periods, and a plurality of execution start times are included in the same sub period from among the plurality of sub periods, the processor 120 may calculate an individual weighted value by changing differences between each of the plurality of execution start times and a present time to be identical.

The processor 120 may calculate an individual weighted value of usage history where a user interaction is input to be higher than an individual weighted value of usage history where a user interaction is not input after a notification is generated by the application

The processor 120 may calculate an individual weighted value of usage history where a user interaction is input without a notification by the application to be higher than an individual weighted value of usage history where a user interaction is input after a notification is generated by the application.

The user terminal apparatus 100 may further include a display configured to display an application list, and the processor 120 may control the display to display applications which are determined to be inactivated differently from other applications in the application list.

The processor 120 may determine whether to inactivate an application based on extracted usage history data either when the user terminal apparatus 100 is recharged or when a certain period arrives. The certain period may be predetermined.

The usage history data related to a user interaction includes the title, the execution start time and the execution end time of an application, and if the difference between the execution start time and the execution end time is greater than a threshold value, the processor 120 may store the usage history data in the storage 110. The threshold value may be predetermined.

FIG. 1B is a block diagram illustrating detailed configuration of a user terminal apparatus 100′ according to another exemplary embodiment. Referring to FIG. 1B, the user terminal apparatus 100′ includes the storage 110, the processor 120, a display 130, a user interface module 140, a communicator 150, an audio processor 160, a video processor 170, a speaker 180, a button 181, a camera 182, and a microphone 183. The elements of FIG. 1B which are overlapped with the elements of FIG. 1A will not be described in detail.

The processor 120 controls the overall operations of the user terminal apparatus 100 using various programs stored in the storage 110.

Specifically, the processor 120 may include a RAM 121, a ROM 122, a main CPU 123, a graphic processor 124, first to n-th interfaces 125-1 to 125-n, and a bus 126.

The RAM 121, the ROM 122, the main CPU 123, the graphic processor 124, and the first to n-th interfaces 125-1 to 125-n may be connected with one another via the bus 126.

The first to n-th interfaces 125-1 to 125-n may be connected with the above-described various elements. One of the interfaces may be a network interface which is connected with an external device via a network.

The main CPU 123 may access the storage 110 and perform booting using an operating system (O/S) stored in the storage 110. In addition, the main CPU 123 may perform various operations using various programs, contents, data, etc. stored in the storage 110.

The ROM 122 may store a set of instructions for booting a system. In response to a turn on command being inputted and power being supplied, the main CPU 123 may copy the O/S stored in the storage 110 into the RAM 121 according to a command stored in the ROM 122, and boot the system by executing the O/S. In response to the booting being completed, the main CPU 123 may copy various application programs stored in the storage 110 into the RAM 121, and perform various operations by executing the application programs copied into the RAM 121.

The graphic processor 124 may generate a screen including various objects such as an icon, an image, a text, etc., using a calculator (not shown) and a renderer (not shown). The calculator (not shown) may calculate attribute values of objects to be displayed according to a layout of the screen, such as a coordinate value, a shape, a size, a color, etc., based on a received control command. The renderer (not shown) may generate the screen of various layouts including objects based on the attribute values calculated by the calculator (not shown). The screen generated by the renderer (not shown) may be displayed in a display area of the display 130.

The operations of the above-described processor 120 may be performed by a program stored in the storage 110.

The storage 110 stores various data such as an Operating System (O/S) application module to drive the user terminal apparatus 100′, an application usage history data analysis module, various service providing modules, various content information, etc.

In particular, the storage 110 may store usage history data of an application which is installed in the user terminal apparatus 100′ according to an exemplary embodiment.

In this case, the processor 120 may extract usage history data regarding a user interaction from information stored in the storage 110, and determine whether to inactivate an application based on the extracted usage history data.

The display 130 may display various screens under the control of the processor 120. For example, the display 130 may display an application list.

The display 130 may be realized as a Liquid Crystal Display Panel (LCD), an Organic Light Emitting Diodes (OLED), etc., but is not limited thereto. In addition, the display 130 may also be realized as a flexible display, a transparent display, etc. depending on exemplary embodiments.

The user interface module 140 receives various user interactions.

If the user terminal apparatus 100′ is realized as a touch-based portable terminal, the user interface module 140 may be implemented in the form of a touch screen forming a mutual layer structure with a touch pad. In this case, the user interface module 140 may be used as the above-described display 130.

The touch sensor (not shown) may be realized as capacitive or resistive sensor. The capacitive sensor calculates a touch coordinates by sensing micro-electricity excited by a user body when part of the user body touches the surface of a display using a dielectric coated on the surface of the display. The resistive sensor includes two electrode plates built in the user terminal apparatus 100′, and calculates a touch coordinates as the upper and lower plates of the touched point contact with each other to sense flowing electric current when a user touches a screen. In addition, a infrared detecting method, a surface acoustic wave method, an integral strain gauge method, a piezo effect method, etc. may be used to detect a touch interaction.

The communicator 150 may perform communication with an external apparatus according to various types of communication methods.

The communicator 150 includes a WiFi chip 151, a Bluetooth chip 152, a wireless communication chip 153, etc. The WiFi chip 151 and the Bluetooth chip 152 perform communication using the WiFi method and the Bluetooth method, respectively. When the WiFi chip 151 or the Bluetooth chip 152 is used, a variety of connectivity information such as SSID and a session key may be transmitted and received first, and communication is established using the connectivity information, and then a variety of information may be transmitted and received. The wireless communication chip 153 refers to a chip which performs communication according to various communication standards such as IEEE, Zigbee, 3^{rd} Generation (3G), 3^{rd} Generation Partnership Project (3GPP), Long Term Evolution (LTE), etc. The communicator 150 may further include an NFC chip which operates using the NFC method where a band of 13.56 MHz from among various RF-ID frequency bands such as 135 kHz, 13.56 MHz, 433 MHz, 860-960 MHz, 2.45 GHz, etc. is used.

The audio processor 160 processes audio data. The audio processor 160 may perform various processing with respect to audio data such as decoding, amplification, noise filtering, etc.

The video processor 170 processes video data. The video processor 170 may perform various processing with respect to video data such as decoding, scaling, noise filtering, frame rate conversion, resolution conversion, etc.

The speaker 180 outputs not only various audio data processed by the audio processor 160 but also various alarm sounds or voice messages.

The button 181 may a button in various forms like a mechanic button, a touch pad, a wheel, etc. which is formed on a certain area of the user terminal apparatus 100′ such as the front, side, or back of the exterior of the main body.

The camera 182 is an element to photograph a still image or a video under the control of a user. A plurality of cameras 182 such as a front camera and a rear camera may be provided. The microphone 183 is an element to receive a user voice or other sounds and convert the same into audio data.

Hereinafter, basic configuration and various exemplary embodiments will be described to help understanding of an exemplary embodiment.

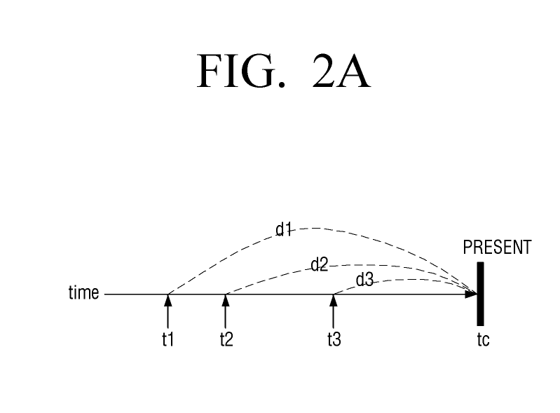

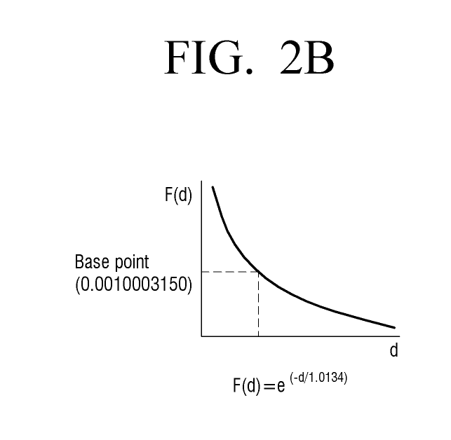

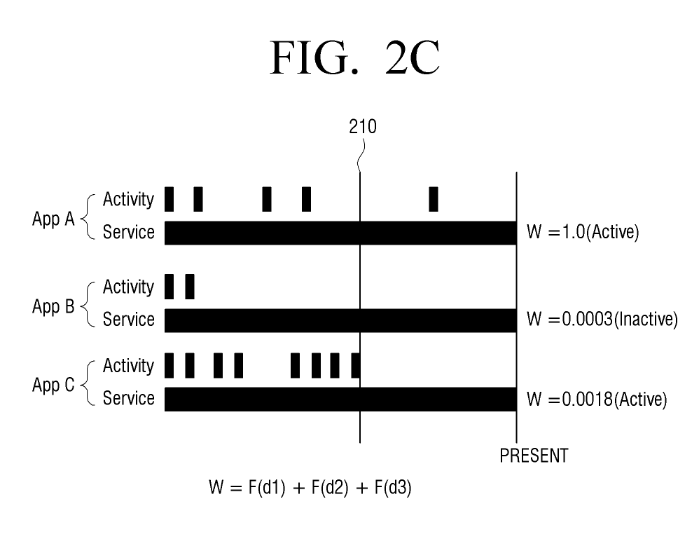

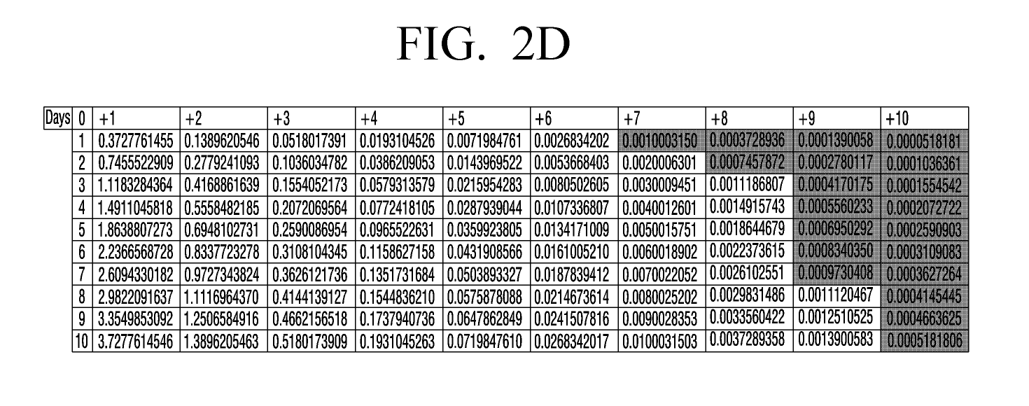

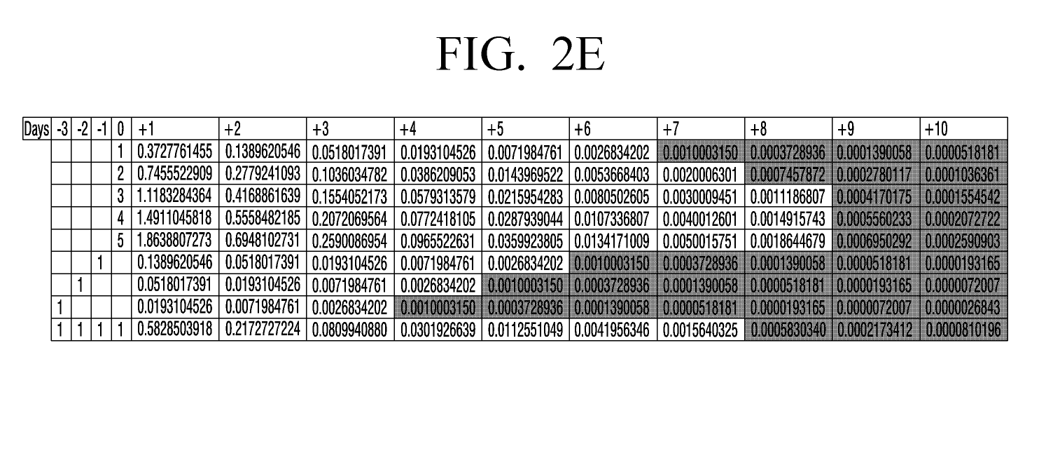

FIGS. 2A-2E are views provided to explain a method of determining whether to inactivate an application according to exemplary embodiments.

Referring to FIG. 2A, the processor 120 may extract usage history data regarding a user interaction from stored usage history data, and determine whether to inactivate an application based on the extracted usage history data. As described above, the usage history data regarding a user interaction may include usage history data bay a user interaction and usage history data which induces a user interaction without the user interaction.

The usage history data may include information regarding an execution start time of an application compiled over a period. The period may be predetermined. For example, the period may be 40 days and thus, usage history data may be deleted after the 40 days has elapsed. However, this is only an example, the period may be a week or a month, and may also be set by a user. The usage history data may be deleted immediately after a period has elapsed or when certain conditions are satisfied. For example, the usage history data may be deleted when power is applied to a user terminal apparatus or a certain time arrives.

The processor 120 may determine whether to inactivate an application based on differences d1, d1, d3 between each of execution start times t1, t2, t3 and a present time tc. For example, the processor 120 may add up all of the differences d1, d1, d3 between each of execution start times t1, t2, t3 and a present time tc and compare the sum of the differences with a threshold value to determine whether to inactivate an application. The threshold value may be predetermined. However, this is only an example, and the processor 120 may not use all of the differences d1, d1, d3 between each of execution start times t1, t2, t3 and a present time tc, but may in some cases use only the differences d2, d3 regarding execution start times t2 and t3 which are close to the present time. In addition, the processor 120 may add a weighted value to each of the differences d1, d2, d3 regarding execution start times t1, t2, t3 and add up the weighted differences, or a portion of the weighted differences.

Referring to FIG. 2B, the processor 120 may calculate an individual weighted value F(d) regarding each of the execution start times based on differences (d) between each of the execution start times and a present time. In particular, the processor 120 may calculate an individual weighted value F(d) corresponding to differences (d) between each of the execution start times and a present time using a weight function.

The weight function models memories of a human being, and may be represented as an exponential function. According to the formula of FIG. 2B, the difference (d) between an execution start time of an application and a present time is an independent variable from which an individual weighted value F(d) which is dependent variable is calculated. In the formula, the value 1.0134 is only an example, and the value may be set differently depending on user's circumstances. For example, the figure may be set differently depending on user's concentration, life environment, intelligence, etc.

According to the weight function, in general, approximately 25% of a person's memory is maintained after 7 days have passed. Accordingly, the base point (0.0010003150) may be set based on the premise that the difference (d) between an execution start time of an application to a present time is 7 days. However, this is only an example, and the base point may be determined by setting the difference (d) between an execution start time of an application to a present time to be another value rather than 7 days. The processor 120 may determine whether to inactivate an application based on a base point and an individual weighted value F(d). In addition, it is possible to adjust the value of the base point by setting the difference (d) between an execution start time of an application to a present time to a desired value. Hereinafter, calculating an individual weighted value F(d) with reference to a formula will be described.

Referring to FIG. 2C, the processor 120 may determine whether to inactivate an application using the sum of calculated weighted values. FIG. 2C illustrates usage history data of Applications A, B, C, respectively. The notation “Activity” represents usage history data regarding a user interaction, and the notation “Service” represents usage history data according to background execution.

Application A has been used frequently not only before a point of time 210 which is 7 days ago but also after the point of time 210. Accordingly, the sum (W) of individual weighted values regarding each of the execution start times based on the differences between each of the execution start times of Application A and the present time is 1, and Application A can maintain its active state. Here, it is assumed that the sum (W) of the individual weighted values is 1.

Application B has not been used frequently before the point of time 210 which is 7 days ago and has not been used at all after the point of time 210. Accordingly, the sum (W) of individual weighted values of Application B is 0.0003 which is lower than the above-mentioned base point, and Application B is bound to be in an inactive state.

Application C has been used frequently before the point of time 210 which is 7 days ago, but has not been used at all after the point of time 210. The sum (W) of individual weighted values of application C is 0.0018 which is higher than the above-mentioned base point, and Application C can maintain its active state.

Meanwhile, the processor 120 may divide a period into a plurality of sub periods, and if a plurality of execution start times are included in the same sub period, individual weighted values may be calculated by changing the differences between each of the plurality of execution start times and a present time to be identical. The period may be predetermined.

For example, the processor 120 may calculate an individual weighted value by assuming that a case where the difference between an execution start time of an application and a present time of 2 days is the same as the case where the difference between an execution start time of another application and a present time is 2 days and 12 hours. Consequently, as the input value of the same period is the same, an individual weighted value for the same sub period may become identical.

FIG. 2D displays the sum of individual weighted values according to usage history data related to at least user interaction during the same sub period. The values of FIG. 2D have been calculated based on the formula of FIG. 2B and the assumption that the sub period is 1 day. The first row of FIG. 2D represents the progress of a day. However, this is only an example, and other values may be applied. The first column of FIG. 2D represents the number of usage history data related to a user interaction in day 0.

First, if the usage history data related to a user interaction in day 0 is 1 and 1 day has passed (day+1), the value of 0.3727761455 is calculated as the sum of individual weighted values. When 7 days has passed (day+7), the value of 0.0010003150 is calculated as the sum of individual weighted values, and the processor 120 may compare the value with the base point to determine that an application is subject to inactivation. Before the 7 days have passed, the processor 120 does not determine that the application is subject to inactivation.

If the usage history data related to a user interaction in day 0 is 2, and 1 day has passed (day+1), the value of 0.7455522909 may be calculated as the sum of individual weighted values. The value is twice of the value when the usage history data related to a user interaction in day 0 is 1 and 1 day has elapsed (day +1). In other words, an individual weighted value has been calculated twice as there are two usages on the same date and thus, the sum becomes double.

Subsequently, after 8 days has passed (day+8), the value of 0.0007457872 is calculated as the sum of individual weighed values, and the processor 120 may compare the value with the base point to determine that the application is subject to inactivation.

As described above, the processor 120 may calculate the sum of individual weighted values by reflecting the number of usage history data related to a user interaction during the same sub period. Accordingly, if the number of usage data related to a user interaction in day 1 is 10, the processor 120 may compare the value with the base point to determine that the application is subject to inactivation only when 10 days have passed (day+10).

FIG. 2E displays the sum of individual weighted values regarding usage history data related to a user interaction during a plurality of sub periods. The values of FIG. 2E have been calculated based on the formula of FIG. 2B and the assumption that the sub period is 1 day. The properties of line and row of FIG. 2E are the same as those of FIG. FIG. 2D.

If the usage history data related to a user interaction on day−1 is 1 and 2 days have passed (day 1), the value of 0.1389620546 is calculated as the sum of individual weighted values. This value is the same as the value when the usage history data related to a user interaction in day 0 is 1 and two days have passed (day 2). In the same manner, if the usage history data related to a user interaction in day−2 is 1 and 3 days have passed (day 1), the value becomes smaller. Accordingly, the processor 120 determines that the application is subject to inactivation in day 6 in case where the usage history data related to a user interaction in day−1 is 1 and in day 5 in case where the usage history data related to a user interaction in day−2 is 1.

If the usage history data related to user interaction in days 0, −1, −2, and −3 is 1, respectively, the processor 120 may add up an individual weighted value when 1 day has passed from day 1, an individual weighted value when 2 days have passed from day−1, an individual weighted value when 3 days have passed from day−2, and an individual weighted value when 4 days have passed from day−3 in order to calculate the sum of individual weighed values of day 1. In addition, if the number of usage history data related to a user interaction in days 0, −1, −2, and −3 is 1, respectively, it may be determined that the point of time (shaded part in FIG. 2E) to determine whether to inactivate the application is day 8. In other words, if there are a plurality of usages as described above, the processor 120 may determine that the user terminal apparatus 100 is being used frequently and delay the determination regarding whether to inactivate the application.

In the above description, the processor 120 calculates individual weighted values in the same manner and adds up the values, but this is only an example. For example, the processor 120 may calculate individual values using the same method, add a weighted value to each of the individual weighted values and add up the values. Alternatively, the processor 120 may calculate individual weighted values by using different methods according to the differences between execution start times of an application and a present time.

The processor 120 may determine whether to inactivate an application based on usage history data which is extracted either when the user terminal apparatus 100 is recharged or when a time arrives. The time may be predetermined. However, this is only an example, and the processor 120 may determine whether to inactivate an application based on usage history data which is extracted in real time.

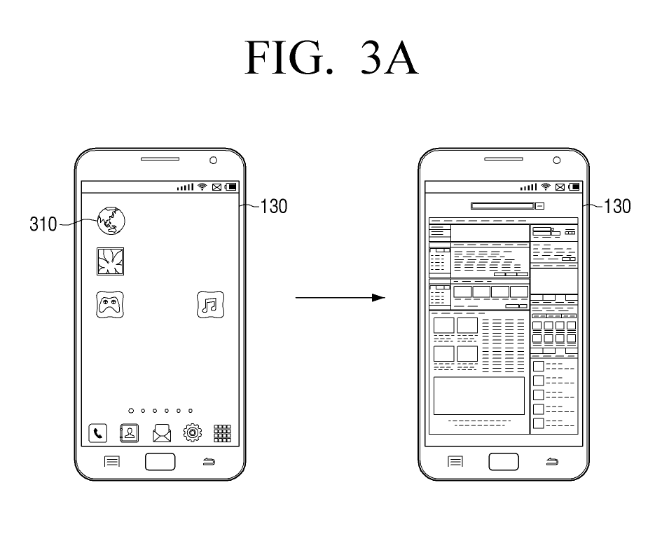

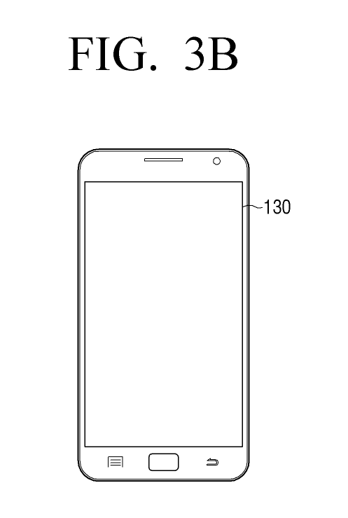

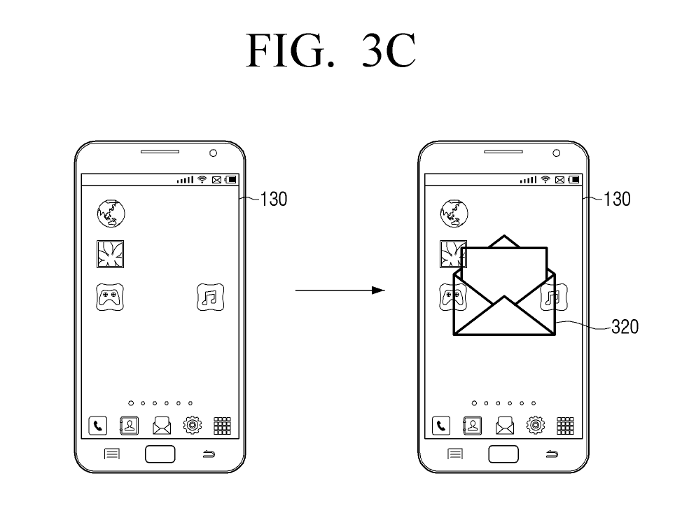

FIGS. 3A-3C are views provided to explain storage of usage history data of an application according to exemplary embodiments.

Referring to FIG. 3A, the processor 120 may display a plurality of widgets through the display 130. If a user interaction regarding Internet widget 310 is input, the processor 120 may execute an Internet application. In addition, the processor 120 may store the title of the application, the execution start time of the application, the execution end time by a user, etc. as usage history data related to the user interaction. However, this is only an example, and the processor 120 may further store the resources occupation rate, the battery level, etc. of the Internet application.

In particular, the processor 120 may store usage history data when the difference between an execution start time and an execution end time is greater than a threshold value. The threshold value may be predetermined. For example, the processor 120 may store usage history data only when the execution time of an application is more than 10 minutes. The threshold value may set by a user.

In addition, the processor 120 may store usage history data only when the execution of an application is ended and the application is executed in background. Depending on the type of applications, some applications may be executed continuously in background even if there is a user command to terminate the execution of the applications, and the processor 120 may store usage history data only when the applications are executed in background in order to terminate the applications which are executed in background and are consuming resources and batteries.

Referring to FIG. 3B, the processor 120 may store usage history data of an application which is executed in background. For example, applications such as a security application and a communication application may be executed automatically even if a user interaction is not input. Alternatively, applications such as a game-related application and an advertisement application, which are not essential applications such as a security application or a communication, may be executed in background. The processor 120 may store all usage history data in order to prevent non-essential applications from being executed in background and consuming resources and batteries.

The processor 120 may determine whether to inactivate an application only regarding the applications which are executed in background without a user interaction.

Referring to FIG. 3C, the processor 120 may store usage history data regarding an application which provides a notification 320 from among applications which are executed in background. For example, a message application may be executed in background without a user interaction, and once a message is received, may provide the notification 320 notifying a user that the message has been received. The notification 320 may be stored as usage history data by a user interaction as described above, or as usage history data related to a user interaction without the user interaction.

The processor 120 may calculate an individual weighted value of usage history where user interaction is input to be higher than an individual weighted value of usage history where a user interaction is not input after the notification 320 is generated by an application. For example, the processor 120 may calculate an individual weighted value of usage history where a user interaction is input after a message notification is generated and the message is opened or usage history where a user interaction regarding a widget representing a specific application to be higher than an individual weighted value of usage history where a user interaction is not input after a message notification is generated. In other words, the processor 120 may determine that a case with a user interaction is more important than others, and determine whether to inactivate an application accordingly.

In addition, the processor 120 may calculate an individual weighted value of usage history where a user interaction is input without a notification of an application to be higher than an individual weighted value of usage history where a user interaction is input after a notification is generated by an application. For example, the processor 120 may calculate an individual weighted value of usage history where a user interaction regarding a widget representing a specific application is input to be higher than an individual weighted value of usage history where a user interaction to check a message after a message notification is generated is input. In other words, the processor 120 may determine that a user interaction by a user's own intention is more important than a user interaction induced by an application, and determine whether to inactivate the application accordingly.

The processor 120 may store usage history data directly in the storage 110, but this is only an example. For example, the processor 120 may store usage history data in a buffer, and store the usage history data in the storage 110 at time intervals. The time intervals may be predetermined.

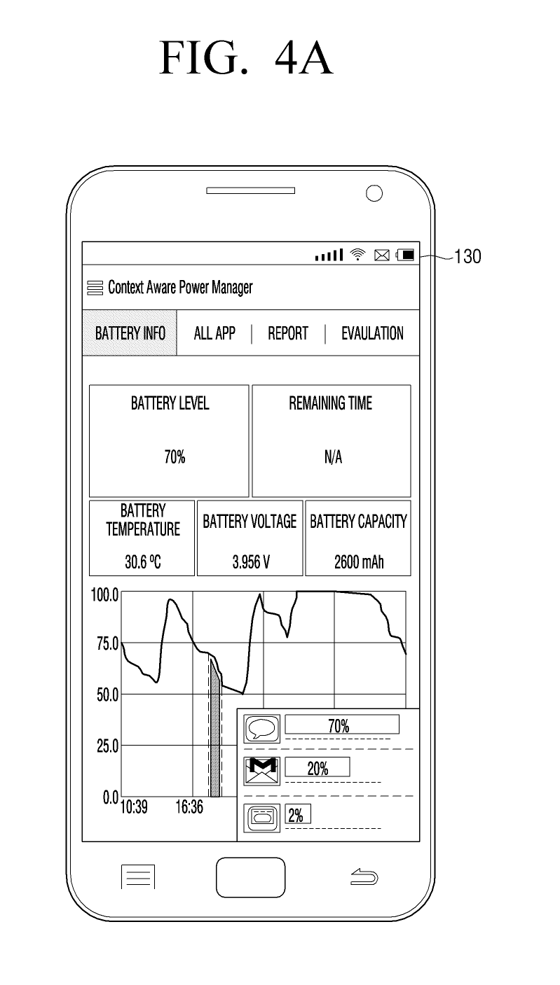

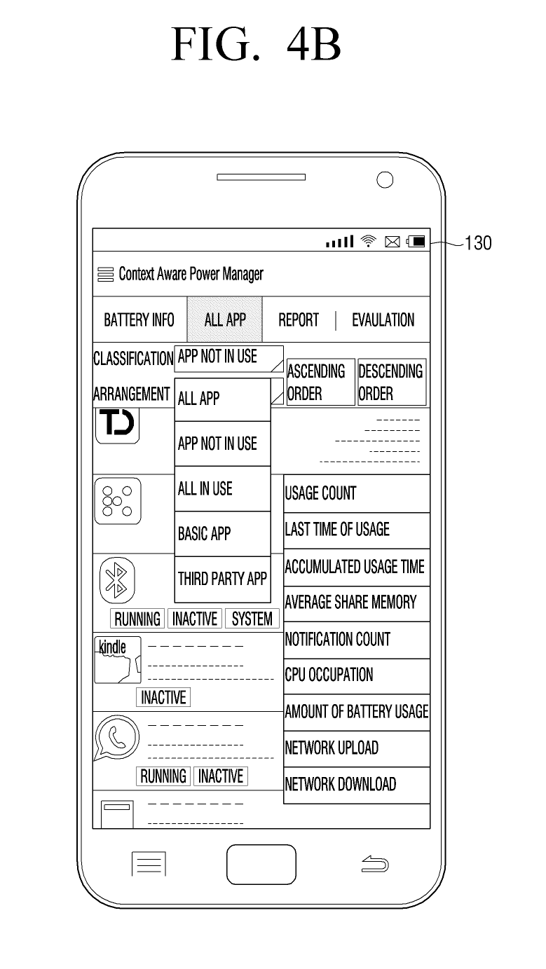

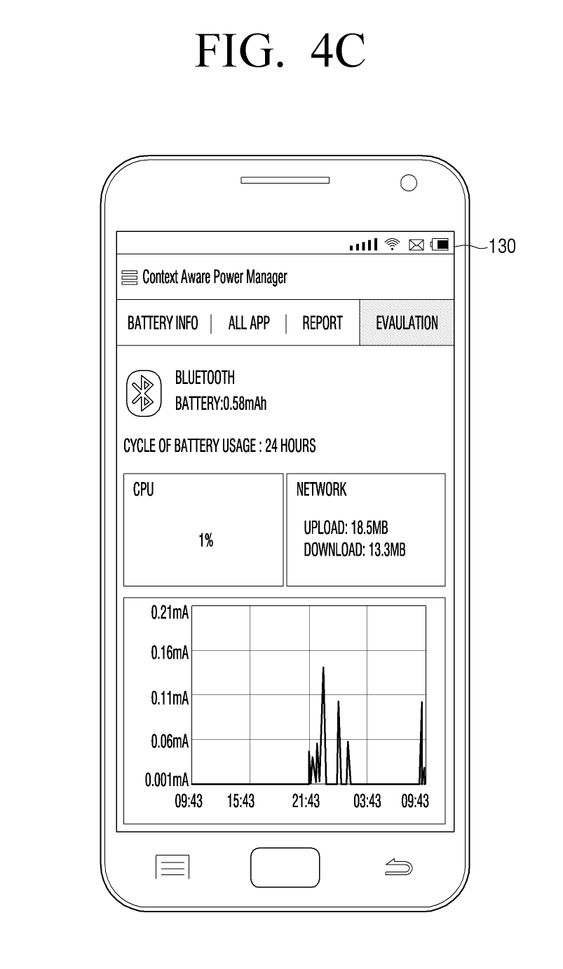

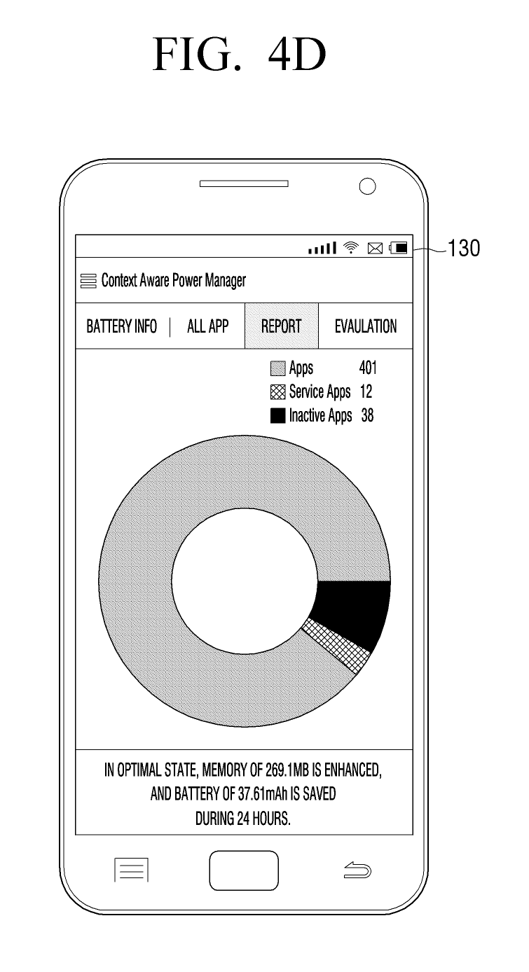

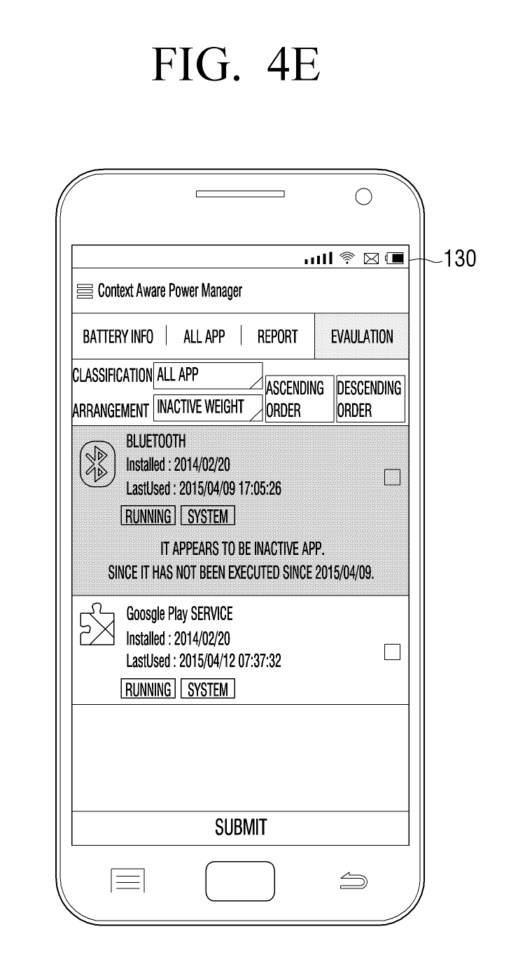

FIGS. 4A-4E are views provided to explain various analysis screens which are provided according to exemplary embodiments.

Referring to FIG. 4A, the processor 120 may provide battery information. The battery information may include information regarding a battery level, a remaining time, a battery temperature, a battery voltage, and a battery capacity, etc.

In addition, the processor 120 may provide battery usage by time. In addition, the processor 120 may provide battery usage by application at a specific time. For example, the processor 120 may display battery usage at a specific time such that an SNS application has consumed 70%, an e-mail application has consumed 20%, and a message application has consumed 2%. Accordingly, a user may recognize that battery has been used significantly for an SNS application at a specific time.

Referring to FIG. 4B, the processor 120 may provide usage history data of all applications which are installed in the current user terminal apparatus 100. The usage history data of an application may include information regarding the number of usage of an application, usage time, battery usage, etc.

The processor 120 may provide information regarding all applications, but is not limited thereto. For example, the processor 120 may categorize information regarding applications as applications which are not in use, applications which are in use, basic installation applications, third-party applications, etc. Here, the applications which are not in use are applications which are inactivated by a user or by the processor 120.

In addition, the processor 120 may provide applications by properties. For example, the processor 120 may provide applications according to the number of uses, the time of the last use, the accumulated usage time, the average occupation memory, the number of notifications, the CPU occupation, the battery level, the network upload, network download, etc.

Referring to FIG. 4C, when one of the applications displayed in FIG. 4B is selected, the processor 120 may display detailed information regarding the selected application.

The processor 120 may provide the title of an application, the CPU occupation rate, the average battery level, the network upload amount, the network download amount, the battery level by time, etc.

Referring to FIG. 4D, the processor 120 may analyze all applications installed in the user terminal apparatus 100 to provide information for optimization of the user terminal apparatus 100. For example, the processor 120 may notify that the total number of applications which are installed is 401 and among them, 38 applications are inactive applications. When those applications are inactivated, the processor 120 may provide information regarding the secured memory and battery. In other words, the processor 120 may provide information indicating the amount of memory that is freed up and the amount of battery that is saved by inactivating the applications.

Referring to FIG. 4E, the processor 120 may provide an application list through the display 130. In particular, the processor 120 may display those applications which are determined to be subject to inactivation differently from other applications. For example, the processor 120 may display the applications which are determined to be subject to inactivation in a grey background and other applications in a white background.

The processor 120 may provide a check box to select applications which are determined to be subject to inactivation and a “submit” button. If a user selects a check box and presses a “submit” button, the processor 120 may inactivate or delete the corresponding applications. If the check box of applications which are subject to inactivation is not selected, the processor 120 may not inactivate the corresponding applications. If an individual weighted value of the corresponding application is calculated, the processor 120 may calculate the individual weighted value to be higher than before.

Meanwhile, if an inactivated application is executed again without a user interaction, the processor 120 may inactivate again or delete the corresponding application.

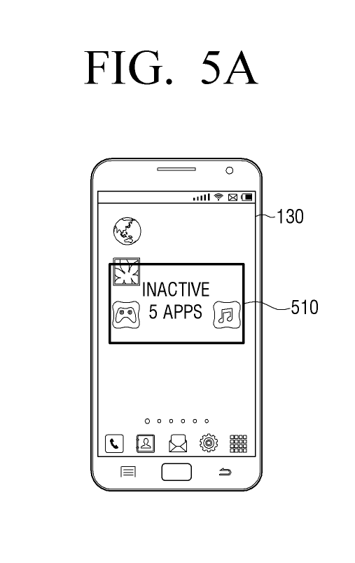

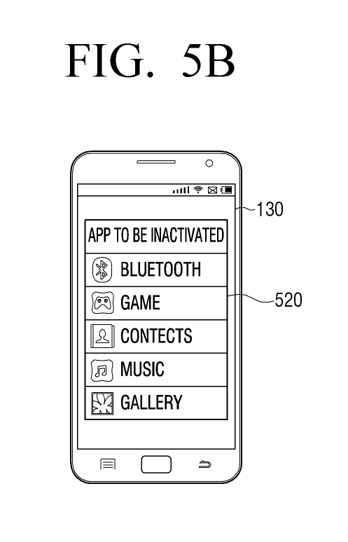

FIGS. 5A-5B are views provided to explain an operation of inactivating an application according to exemplary embodiments.

Referring to FIG. 5A, the processor 120 may inactivate an application which is subject to inactivation directly. In this case, the processor 120 may display a message 510 indicating that the application has been inactivated. If there is a user interaction of touching a message, the processor 120 may provide a list of applications which have been inactivated.

As described above, the processor 120 may inactivate all of the applications which are subject to inactivation directly. However, this is only an example, and another standard may be applied when the processor 120 directly inactivates the applications. For example, the processor 120 may determine whether to inactivate an application directly with reference to a value which is lower than the above-described base point. Alternatively, the processor 120 may determine whether to inactivate applications directly with reference to the battery level from among applications which are subject to inactivation.

Referring to FIG. 5B, if a user executes a specific application, the processor 120 may display a list 520 of applications which are subject to inactivation. If the user selects some of those applications which are subject to inactivation, the processor 120 may inactivate the selected applications.

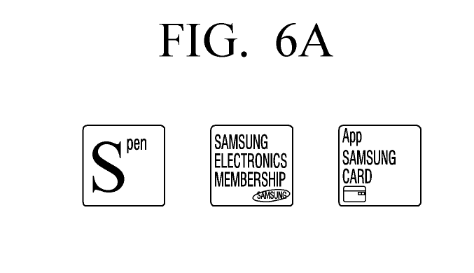

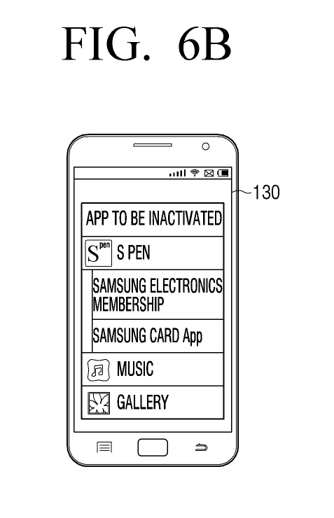

FIGS. 6A-6B are views provided to explain an example of providing a related application according to exemplary embodiments.

FIG. 6A illustrates related applications by the same developer. There may be a case where even if one of the related applications is inactivated, the execution of another related application leads to activating the inactivated related application. For example, if the Samsung Electronics membership application is executed when the “S pen” application is inactivated, the “S pen” application may be activated. In other words, an application which is inactivated by a user because the user considers the application unnecessary may be activated without a user interaction.

Referring to FIG. 6B, if the “S pen” application is included in the list of applications which are subject to inactivation, the processor 120 may provide the Samsung Electronics membership application and the Samsung card application which are not subject to inactivation as related applications. In addition, according to a user input, the processor 120 may inactivate not only those applications subject to inactivation but also related applications.

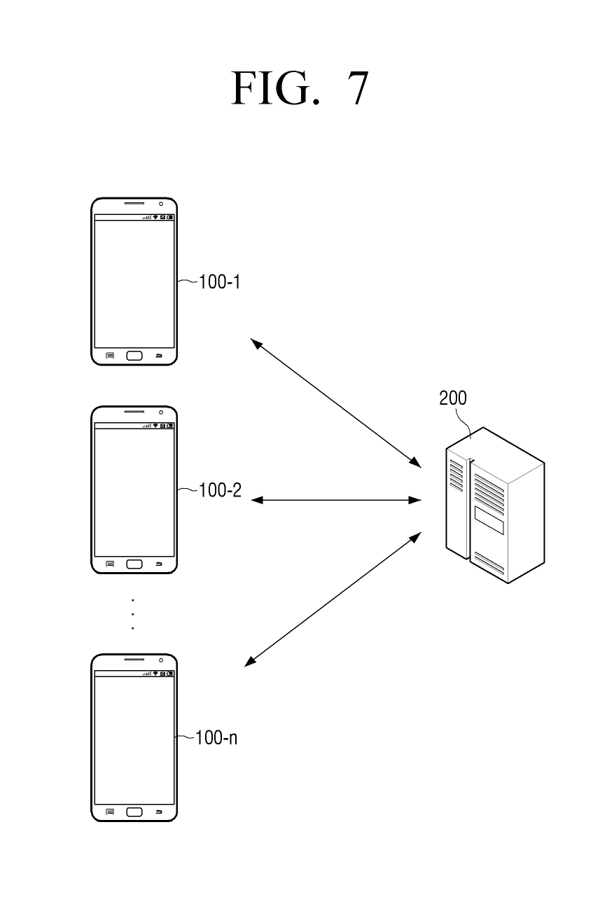

FIG. 7 is a view provided to explain an example of determining whether to inactivate an application using a server according to another exemplary embodiment.

Referring to FIG. 7, a plurality of user terminal apparatuses 100-1-100-n may perform communication with a server 200. The plurality of user terminal apparatuses 100-1-100-n may transmit usage history data regarding an application which is installed in each of the user terminal apparatuses to the server 200. For example, if an Internet application is executed, a user terminal apparatus may transmit the resources occupation rate, the battery occupation rate, etc. to the server 200. In addition, the user terminal apparatus may also transmit usage history data of an application which is executed in background to the server 200.

The server 200 may store usage history data of each application and calculate statistics thereof. For example, the server 200 may receive and store the battery occupation rate of the Internet application in the plurality of user terminal apparatuses 100-1-100-n, and calculate statistics. In addition, the server 200 may transmit the calculated statistics to the plurality of user terminal apparatuses 100-1-100-n. In this case, the server 200 may transmit the calculated statistics upon q request from a user terminal apparatus or at a certain time. The certain time may be predetermined.

A user terminal apparatus may receive the calculated statistics from the server 200 and store the statistics. The user terminal apparatus may compare the execution state of a specific application with the stored statistics to determine an abnormality. For example, if the memory usage amount of a message application of the user terminal apparatus is 10 MB and the memory usage amount of the message application from of the stored statistics is 1 MB, the user terminal apparatus may determine that the message application is operated abnormally. Subsequently, the user terminal apparatus may notify a user that the message application is subject to inactivation.

In the above description, a user terminal apparatus determines whether to inactivate an application by analyzing usage history data of the application directly or by using statistics calculated from the server 200. However, this is only an example, and the user terminal apparatus may transmit the usage history data to the server 200, and when the server 200 determines whether to inactivate the application, may receive the determination result from the server 200.

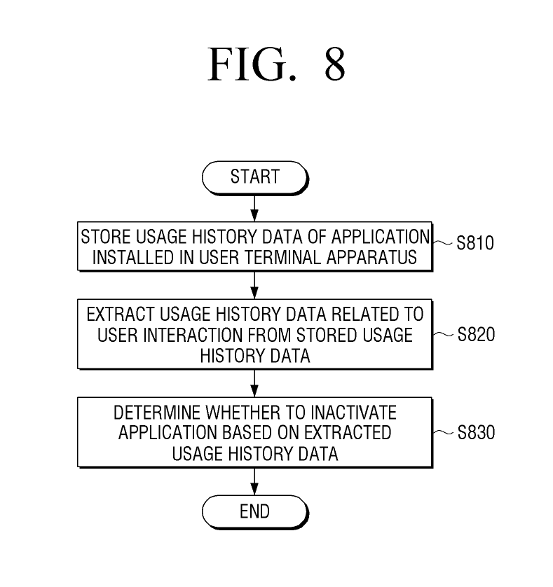

FIG. 8 is a flowchart provided to explain a controlling method of a user terminal apparatus according to an exemplary embodiment.

First, the usage history data of an application which is installed in a user terminal apparatus is stored (S810). Among the stored usage history data, usage history data related to a user interaction is extracted (S820). Subsequently, whether to inactivate the application is determined based on the extracted usage history data (S830).

The usage history data includes information regarding execution start times of an application during a period, and the operation of determining (S830) may include determining whether to inactivate the application based on the differences between each of the execution start times and a present time. The period may be predetermined.

In addition, the operation of determining (S830) includes calculating individual weighted values regarding each of the execution start times based on the differences between each of the execution start times and a present time and determining whether to inactivate the application by using the sum of the calculated weighted values.

The operation of calculating includes calculating individual weighted values corresponding to the differences between each of the execution start times and a present time using a weight function.

If the period may be divided into a plurality of sub periods, and a plurality of execution start times are included in the same sub period from among the plurality of sub periods, an individual weighted value may be calculated by changing differences between each of the plurality of execution start times and a present time to be identical. The period may be predetermined.

The operation of calculating may include calculating an individual weighted value of usage history where a user interaction is input to be higher than an individual weighted value of usage history where a user interaction is not input after a notification is generated by the application.

The operation of calculating may include calculating an individual weighted value of usage history where a user interaction is input without a notification by the application to be higher than an individual weighted value of usage history where a user interaction is input after a notification is generated by the application.

The operation of determining (S830) may include displaying applications which are determined to be inactivated differently from other applications in the application list.

The operation of determining (S830) may include determining whether to inactivate the application based on the extracted usage history data either when the user terminal apparatus is recharged or when a time arrives. The time may be predetermined.

The usage history data related to a user interaction may include a title, an execution start time and an execution end time of the application, and the operation of storing (S810) may include, in response to a difference between the execution start time and the execution end time being greater than a threshold value, storing the usage history. The threshold value may be predetermined.

According to the various exemplary embodiments, a user terminal apparatus may determine whether to inactivate an application based on usage history data related to a user terminal apparatus and inactivate unnecessary applications, thereby improving efficiency of resources and battery to enhance user convenience.

The methods according to the above-described various exemplary embodiments may be programmed and stored in various storage media. Accordingly, the methods according to the above-described various exemplary embodiments may be realized in various types of electronic apparatuses which execute those storage media.

Specifically, according to an exemplary embodiment, a non-transitory computer readable medium which stores a program for executing the operations of storing usage history data of an application installed in a user terminal apparatus, extracting usage history data related to a user interaction from among the stored usage history data, and determining whether to inactivate the application based on the extracted usage history data sequentially may be provided.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as CD, DVD, hard disk, Blu-ray disk, USB, memory card, ROM, etc.

The foregoing embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A user terminal apparatus comprising:
a storage configured to store usage history data of an application which is installed in the user terminal apparatus; and
a processor configured to extract usage history data related to a user interaction from the stored usage history data, and determine whether to inactivate the application based on the extracted usage history data.

2. The apparatus as claimed in claim 1, wherein the usage history data includes information regarding execution start times of the application during a period,
wherein the processor determines whether to inactivate the application based on differences between each of the execution start times and a present time.

3. The apparatus as claimed in claim 2, wherein the processor calculates individual weighted values regarding each of the execution start times based on the differences between each of the execution start times and a present time, and determines whether to inactivate the application using a sum of the calculated individual weighted values.

4. The apparatus as claimed in claim 3, wherein the processor calculates an individual weighted value corresponding to differences between each of the execution start times and a present time using a weight function.

5. The apparatus as claimed in claim 4, wherein the period is divided into a plurality of sub periods,
wherein the processor, in response to a plurality of execution start times being included in a same sub period from among the plurality of sub periods, calculates the individual weighted value by changing differences between each of the plurality of execution start times and a present time to be identical.

6. The apparatus as claimed in claim 3, wherein the processor calculates an individual weighted value of usage history where a user interaction is input to be higher than an individual weighted value of usage history where a user interaction is not input after a notification is generated by the application.

7. The apparatus as claimed in claim 3, wherein the processor calculates an individual weighted value of usage history where a user interaction is input without a notification by the application to be higher than an individual weighted value of usage history where a user interaction is input after a notification is generated by the application.

8. The apparatus as claimed in claim 1, further comprising:
a display configured to display an application list,
wherein the processor controls the display to display applications which are determined to be inactivated differently from other applications in the application list.

9. The apparatus as claimed in claim 1, wherein the processor determines whether to inactivate the application based on the extracted usage history data either when the user terminal apparatus is recharged or when a time arrives.

10. The apparatus as claimed in claim 1, wherein the usage history data related to a user interaction includes a title, an execution start time and an execution end time of the application,
wherein the processor, in response to a difference between the execution start time and the execution end time being greater than a threshold value, stores the usage history data in the storage.

11. A controlling method of a user terminal apparatus, the method comprising:
storing usage history data of an application which is installed in the user terminal apparatus;
extracting usage history data related to a user interaction from the stored usage history data; and
determining whether to inactivate the application based on the extracted usage history data.

12. The method as claimed in claim 11, wherein the usage history data includes information regarding execution start times of the application during a period,
wherein the determining comprises determining whether to inactivate the application based on differences between each of the execution start times and a present time.

13. The method as claimed in claim 12, wherein the determining comprises:
calculating individual weighted values regarding each of the execution start times based on the differences between each of the execution start times and a present time; and
determining whether to inactivate the application using a sum of the calculated individual weighted values.

14. The method as claimed in claim 13, wherein the calculating comprises calculating an individual weighted value corresponding to differences between each of the execution start times and a present time using a weight function.

15. The user terminal apparatus as claimed in claim 1, wherein the processor inactivates the application based on the determination.

16. The method as claimed in claim 11, wherein the application is inactivated based on the determination.

17. A user terminal apparatus comprising:
a storage configured to store usage history data of an application; and
a processor configured to monitor the stored usage history data for an inactivation condition, and automatically inactivate the application when the inactivation condition occurs.

18. The user terminal apparatus as claimed in claim 17, wherein the inactivation condition comprises a case in which the application has not been used over a period of time.

19. The user terminal apparatus as claimed in claim 17, wherein the usage history data includes execution start times of the application over a period of time.

20. The user terminal apparatus as claimed in claim 17, wherein the usage history data comprises usage history data as a result of a user interaction and usage history data which encourages a user interaction even though there is no user interaction.
